(19) United States
(12) Patent Application Publication
(10) Pub. No.: US 2003/0061393 A1
(43) Pub. Date: Mar. 27, 2003

(54) System and method for improving the management of information in networks by disposing machine accessible information tags along the interconnection means

(76) Inventors: Frank Steegmans, San Jose, CA (US); Sabeur Siala, Sunnyvale, CA (US)

Correspondence Address: FRANK STEEGMANS, 144 S. 3RD STREET, APT 103, SAN JOSE, CA, 95112, US

(21) Appl. No.: 10/253,308

(22) Filed: Sep. 23, 2002

Related U.S. Application Data
(60) Provisional application No. 60/323,955, filed on Sep. 21, 2001.

(51) Int. Cl. G06F 15/173; G06F 15/16

(52) U.S. Cl. 709/250; 709/223

(57) ABSTRACT

Interconnection means in networks are tagged with machine accessible information tags. Relevant information related to the interconnection means (including identification means) is stored and maintained in the corresponding tags. Field technicians have a device to read, write, or update this information. Some of the said machine accessible information tags are attached to the termination point of said interconnection means. This type of tag is typically connected to and disconnected from the tag interface of the network node when the associated termination point is connected and disconnected from the network node. The network node will detect such an event and is able to read, write and update the information residing in the machine accessible information tag while it is connected. A network management system connected to the network nodes can correlate the different termination points of the same interconnection means and hence discover and maintain an accurate view of the network topology.

This application claims priority from provisional application 60/323955 filed Sep. 21, 2001.

### FIELD OF THE INVENTION

This invention generally relates to the field of managing information related to physical recourses in networks. More specifically, this invention relates to mechanisms for identifying, managing and automating discovery of interconnection resources in communication and optical communication networks and to the management of information related to these interconnection resources.

### BACKGROUND OF THE INVENTION

When building networks, network builders typically keep information records of the physical resources they deploy and maintain, according to specific procedures. Mostly these records are maintained in a computer database. Unfortunately, these databases are not always centralized or up-to-date with the latest information because of procedural flaws or human error. Another issue is the accessibility of this information by field personnel who need to perform maintenance on these resources. Field technicians often need to be able to identify and get the information of other resources then the ones they are currently servicing.

Although these problems play in any type of network, they become more cumbersome the larger and more geographically dispersed the network gets. This commonly results in huge financial losses in terms of: underutilization of resources, extra operational costs and opportunity loss. Unused resources that are not registered as available will never be used. Others that are registered as available but are not, will send field crews back on their tracks. Extra procedural overhead will need to compensate for inaccurate records. As a result precious time is lost between the request for a service and the actual activation. Another important aspect is that the network resources make up most of the asset budget of a network operator.

Optical fiber networks in particular are plagued by aforementioned problems. Since the deployed fiber plant mainly determines the value of companies, acquisitions in this sector have been troubled by the lack of accurate network inventories. Because the acquisition value is as inaccurate as the information on which it is based, several deals were abandoned during due diligence. Other deals eventually got closed but acquiring companies were often in for a very unpleasant surprise. Although this invention is applicable to any type of network, we will use optical fiber networks as the main example and example embodiments for this invention.

Optical fibers are often ‘spliced’ (physically connected) from one bundle to the other. Since accurate inventory information is not available, it is often required to trace the fiber by following the route through the different manholes to relate both ends of a spliced fiber. This is a time consuming and expensive operation, which happens more then once in the life time of the particular spliced fiber.

Once the right fiber is found to interconnect two sites, typically patch panels are used to interconnect the optical equipment (OXC or OADMs) on both ends of the fiber. Identifying the right fiber and interconnecting it to the right port on the right switch, is done according to a technician's work order. The work order is produced from the connectivity data entered in the provisioning system. This is obviously very error prone when the provisioning system does not have an accurate view of the fiber plant.

Apart from interconnecting the right fiber with the right switch, optical characteristics are also important for the quality of an optical signal running through the fiber. This information is acquired in test procedures, of which the results are preferably synchronized with the databases of the physical plant and an optional provisioning system. In current practices, management of this information is all done manual and hence very error prone.

Prior art solutions do not address the aforementioned problems. Current solutions don't provide or maintain an accurate view of the deployed resources and their related information, and do not assist field personnel with accurate information of the physical resources or give them immediate feedback, as to avoid errors. Examination of prior art reveals:

1. Currently fibers and other interconnection means are tagged with manual sticky identification labels and traced manually by humans. In other situations, color codes are used to identify fibers in a cable. However, color codes are not unique in dense fiber cables. This identification is used to relate the physical fiber back and forth with information in particular databases.

2. The inventory database of optical fiber plants is completely manually updated and maintained. It usually does not contain the qualitative properties of fibers. Field personnel usually don't have direct access to this information when servicing the plant. This results in expensive roundtrips to a place from where they can access the information. Furthermore, keeping the database information accurate requires rigorous discipline of field personnel who need to record changes in information (configuration, measurements, etc.) and update the appropriate databases when returning to the office. Most provisioning systems are completely detached from the inventory database. I.e. they have their own database providing them an image of the physical resources deducted from the inaccurate inventory database. That this type of approach often lacks, is demonstrated by reports of maintenance personnel who frequently ‘discover’ unregistered fibers during the provisioning process. Or in other cases, find that the fibers that they are supposed to provision are already being used.

3. Smart cards are used for identification, tracking, authentication and accounting purposes.

4. U.S. Pat. Nos. 5,394,503, 5,764,043, 6,222,908 and 6,375,362 disclose a number of systems and methods that all deal with detecting interconnections on patch panels. These systems range from a system that indicates which two inserted connectors relate to the same fiber, to a system that will monitor ports and notify a centralized management system (U.S. Pat. No. 6,375,362 B1 for Heiles et al.). Although they solve some common problems related to patch cords attached to patch panels, they do not address the larger and more costly issues related to physical network resources. As an example, they do not know which two fibers are being ‘patched’ together or which optical characteristics are associated with the interconnection. Either a person or a connected network management system will need to do the correlation of the patched ports to external physical resources. In both cases the overall system approach relies on the assumption that the port configuration information provided to them is accurate. As previously demonstrated this is often a flawed assumption.

### SUMMARY OF THE INVENTION

According to the principles of the present invention, interconnection means in networks are tagged with machine accessible information tags, and relevant information related to the interconnection means (including identification means) is stored and maintained in the corresponding tags. Field technicians or connected network nodes can read, write, or update this information through a device that has an interface to connect the machine accessible information tags.

Key Objects and Advantages

Some of the key advantages over the best prior art solutions include:

1. Easy management of interconnection means by less skilled technicians under machine instructions.

2. Automatic identification of, and information retrieval about the interconnection means by a connected tag enabled device. No need to access a global database. The plant of interconnection means becomes a highly distributed database.

3. Automatic network topology discovery. Until now, this was only possible in communication networks and then only by dedicated link protocols that are part of the higher layer network technologies.

4. Enables integrated management of the physical network plant. For example, an alarm may be generated when a provisioned interconnection medium is unscheduled disconnected. The execution of provisioning work orders may be tracked. For example, the network node is informed about a scheduled connect or disconnect work order. It will detect the completion and inform the network management system. An event containing the identification and potentially other information stored on the tag may be generated when an interconnection means is connected.

Some of the key advantages over the best prior art solutions for optical fiber networks include:

5. Optical measurement tools (i.e. OTDR) equipped with the reader/writer can store the results of the tests or a derivate thereof, directly into the tag. Hence there is no need for a global integration between the inventory database that needs to be updated with these records and the database of the network management system.

6. Enables the integration of patch panels and fiber distribution systems in a Network Management System (NMS) and Operation Support System (OSS) environment.

### BRIEF DESCRIPTION OF THE DRAWINGS

FIG. 1 shows a simplified block diagram of a communications network that is illustrative of one of many possible configurations suitable for use with the present invention. It comprises an at least two-port network interconnection means, such as an optical fiber, that includes one or more tags, and the corresponding network distribution element that can access the contents of such an machine accessible information tag;

FIG. 2 shows a simplified diagram of an illustrative embodiment of the principles of the present invention used for identifying and tracking the usage of fiber patch cords in an optical communication network;

FIG. 3 shows another embodiment of the invention for identifying and tracking the usage of fiber optical splitters or 1×2 couplers;

FIG. 4 shows a third embodiment of the invention for identifying and tracking the usage of optical fixed fiber outside plant;

FIG. 5 shows a simplified schematic drawing of a typical implementation involving the embodiment using a permanently a attached tag on the fiber of FIGS. 2-4, also showing a possible implementation of the mating connector on the tag enabled patch panel;

FIG. 6 shows photographic images of a typical implementation of FIG. 5 using a special LC Connector with the embedded electronic tag and a special LC mating sleeve on a patch panel. Both are equipped with the necessary electronic contacts to power and communicate with the tag from the patch panel;

FIG. 7 shows photographic images of another implementation of FIG. 5 using a tag surface mounted on a LC Connector and a LC mating sleeve equipped with a communication head for such a type of tag.;

FIG. 8 shows a photographic image of the implementation of FIG. 5 using a FC Connector equipped with a snap-on type tag on its boot;

FIG. 9 shows a simplified block diagram of another illustrative implementation of the principles of the present invention using a contact-less induction coupled tag;

FIG. 10 shows a simplified electronic block diagram for powering of, communication with, and control of, the contact-less tag;

FIG. 11 shows a forth embodiment of the principles of the present invention used for identifying and tracking the usage of Fiber Optical Terminators (FOT).

### DETAILED DESCRIPTION OF THE INVENTION

A more complete understanding of the present invention may be obtained from consideration of the detailed description of the invention in conjunction with the drawings, with like elements referenced with like references.

According to the principles of the present invention, interconnection means in networks are tagged with machine accessible information tags and relevant information related to the interconnection means (including identification means) is stored and maintained in the corresponding tags. Field technicians can read, write, or update this information through a device that has an interface to connect to the machine accessible information tags. Some of the said machine accessible information tags may be attached to the termination point of said interconnection means. This type of tag is typically connected to and disconnected from the tag interface of the network node when the associated termination point is connected and disconnected from the network node. The network node will detect these events and is able to read, write and update the information residing in the machine accessible information tag while it is connected. Accordingly it provides the means for automatic discovery, identification, inventorying, and management of the interconnection means. The network management system connected to the network nodes is informed of all the events related to the network node including those of connects and disconnects of the machine accessible information tags. Both the network node and network management system can use the identification information contained in the machine accessible information tags to correlate the different termination points of the same interconnection means. Hence the network node will discover and maintain an accurate view of its own interconnections while the network management system network topology. The network management system can also instruct particular network nodes to update the information on the connected machine accessible information tags.

Although the description in the sequel of this document is focused on optical communications networks, the principles of this invention are also applicable in but not limited to, the following domains: any other communication network, electrical power networks, any kind of gas or liquid distribution network (i.e. water, gas, oil).

One embodiment of this invention is to tag the fiber (or other components in an optical interconnection means) with a tiny electronic, integrated circuit containing a microprocessor and its peripherals at each end, and wherever necessary in between, that will be used to store data (and potentially code) which among others enables the identification of the fiber (e.g. geographical data of both end points, optical characteristics, ownerships, service provider phone numbers, etc).

The installation technician will use a device to program the necessary data in the tag when installing the splices or connectors. This device may integrate an optical analyzer, GPS and mobile connection to analyze the optical characteristics, determine the position of the end point and remotely update the plant database and download the information to be programmed into the machine accessible information tag.

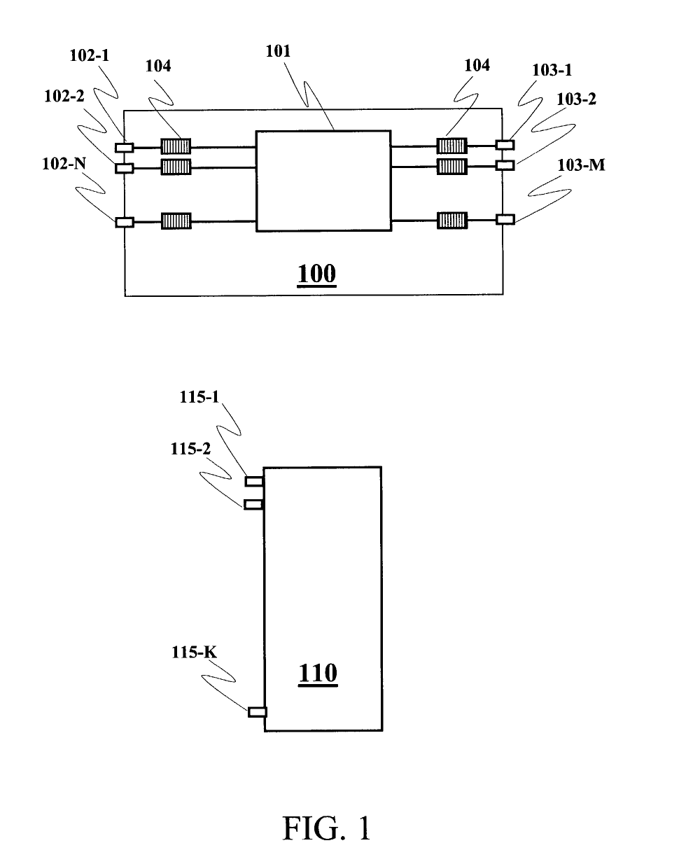

Accordingly, FIG. 1 shows a simplified block diagram of a network in general and, a communication network in particular, that is illustrative of one of many possible configurations suitable for use with the present invention. It comprises at least one interconnection means 100 and at least one network node 110, implemented according to the principles of the present invention. The interconnection means 100 comprises a transmission element 101, with at least one termination point 102-1 though 102-N and 103-1 though 103-M. The interconnection means further includes machine accessible information tags 104 interposed along the element. The tags may be further associated with each of the terminal point of the element 101. The tags 104 contain information related to the transmission element 101, the terminal connectors 103 and 104, the interconnection means 100 and in general about the network. This information may be accessed, i.e., read and or modified by the network node 110. The interconnection means 100 can be a single interconnection medium or an interconnect bundle comprising a plurality of other interconnection means.

The network node 110 comprises of at least one port 115-1 through 115-K that can interconnect with the connectors 102 and 103 of the said interconnection means 100 through the connector ports 114-1 through 115-K.

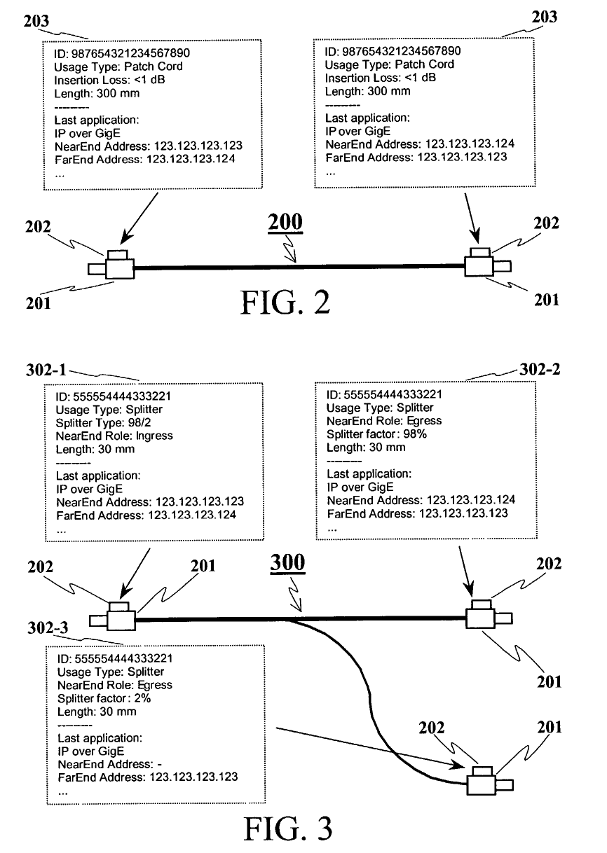

In an optical communication network the interconnection means 100, can be a simple optical patch cord 101 with two connectors 102 and 103 and two machine accessible information tags 104, associated with each of two optical connectors 102 and 103 (FIG. 2). Several embodiments of the machine accessible information tags 104 are described in the subsequent figures. In another illustrative example the transmission medium 101 may be:

an optical splitter with an input connector 102 and two output connectors 103 (FIG. 3);

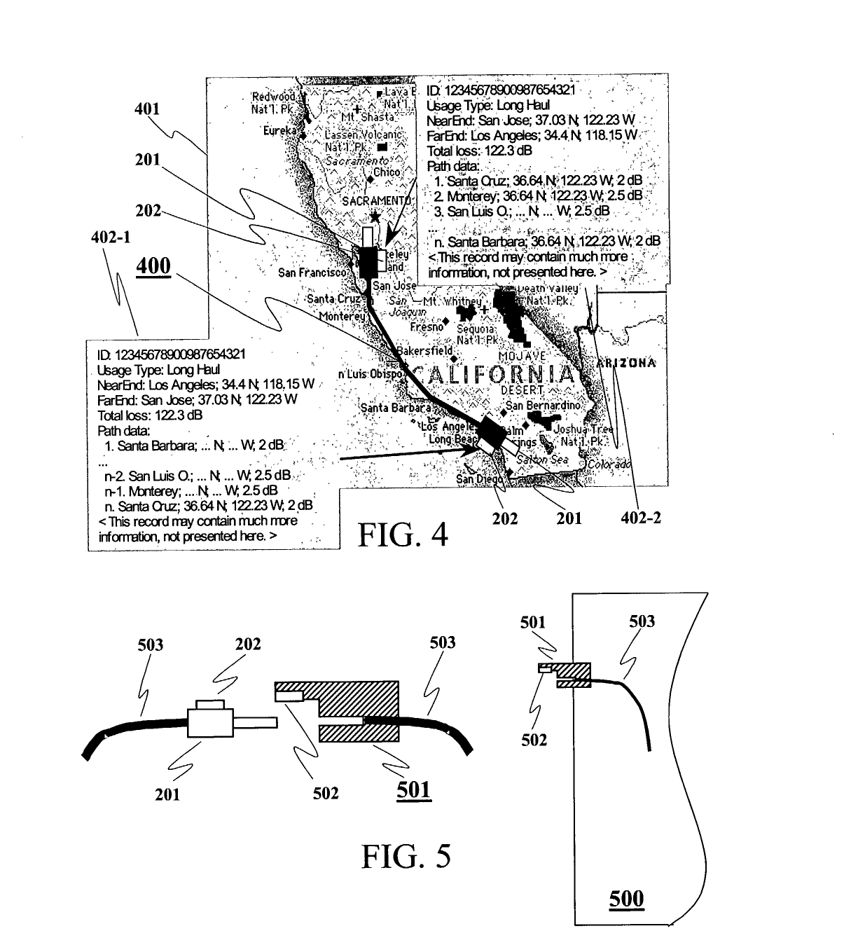

an outside plant long haul fiber transmission line with one terminal connector 102 in Office A and a second terminal connector 103 in a distant office B (FIG. 4);

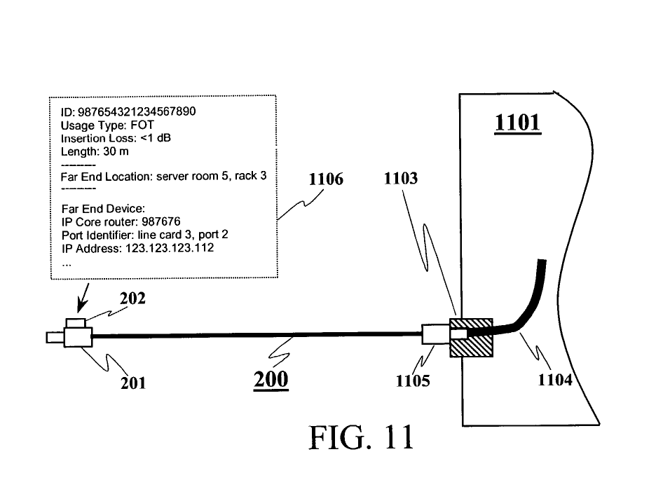

an inside plant fiber transmission line often referred to as an Fiber Optical Terminator (FOT), with two terminal connectors 102 and 103 equipped with one (FIG. 11) or two machine accessible information tags 104.

an optical combiner with two input connectors 102 and one output connector 103;

an optical add/drop multiplexer with multiple terminal connectors 102 and 103 associated with multi-wavelength and single-wavelength ports; and

other possible passive or active network elements that have termination points 103.

In each of the above cases a machine accessible information tag 104 is, illustratively, associated with each of the termination points. In a simple embodiment, the tags are attached to the termination points 102 and 103.

In the illustrative example of the optical communication network, the network node 110 is a K-port smart patch panel with ports 115-1 through 115-K equipped to mate with connectors 102 and/or 103 of the interconnection means 100, and access (read, write and/or modify) the information in the associated tags 104. The smart patch panel further includes the necessary hard- and software intelligence and a communication link to exchange network configuration information and plant inventory with similar network distribution elements, and or, a centralized or distributed network operation support system. In operation, when used in an optical communication network, a number of the smart patch panels 110 and numerous network optical transmission elements 100 form a complex mesh network whose continuation, topology, and the interconnecting element inventory is known to the system at all times. This is the preferred way of operation. Optionally, parts of the network may not be permanently connected to the Operation Support System (e.g. remote patch panels in manholes), in which case a (semi-automatic) inventory reconciliation will be part of the operational procedures. In addition, in such a network, any required changes to the topology, such as during provisioning or network reconfiguration or upgrade, can be facilitated by or supervised through the system intelligence thus reducing possibility of human mistakes and or delay.

The remainder of this section describes in more detail some illustrative embodiments in optical networking application. These figures sole purpose is to illustrate the principles of the invention and are not limiting the extent of the concepts in the invention.

FIG. 2 depicts a conceptual drawing of an embodiment of an interconnection means 100 in the form of a patch cord. The patch cord comprises an optical fiber 200 as transmission element 101 and two optical fiber connectors 201 as terminal connectors 102 and 103. The embodiment of the machine accessible information tag 104 is an electronic chip 202 attached to or molded inside the optical fiber connector 201. The machine accessible information tag information 203 stored in the machine accessible information tag can contain any kind of information interesting to the network node in which it is plugged in as well as to the operation support system. It is mandatory that this information contains a unique identifier or set of information that enables the smart distribution element and/or attached operation support system to correlate the different terminal connectors 102, 103 of a interconnection means 100. 203 depicts typical information that is stored in the machine accessible information tag 104 for this type of embodiment such as the usage type of the transmission element 100, physical parameters such as insertion loss and length as well as application related information such as the protocol and the protocol specific addresses of the near-end and far-end attached equipment. Every interconnection means 100 embodiment will have a typical set of information that will be stored in the machine accessible information tag 104 of each connector. However, it is imperative that this information is not limited to the examples given in this description and that it may even be highly customized depending the particular situation in which interconnection means as well as its terminal connector has been deployed. Other types of information that may be stored on the machine accessible information tag are manufacturing parameters such as manufacturer, date, serial number and operational parameters such as a service records.

FIG. 3 depicts a conceptual drawing of an embodiment of a interconnection means 100 in the form of a 1×2 fiber optical splitter (tap coupler). The smart fiber optical splitter comprises a 1×2 fiber optical splitter 300 as transmission element 101 and three optical fiber connectors 201 as terminal connectors 102, 103-1 and 103-2. Similar as in FIG. 2, the embodiment of the machine accessible information tag 104 is an electronic chip 202 attached to or molded inside the optical fiber connector 201. It should be noted that the information stored in the different machine accessible information tags 104 for a particular embodiment of a interconnection means 100 is not completely the same. The machine accessible information tag information panels 302-1, 302-2 and 302-3 illustrate the information contained in the machine accessible information tags 202 for the smart fiber optical splitter embodiment. 302-1 shows that this machine accessible information tag is attached to the ingress (NearEnd role) of the splitter and that the splitter has two outputs that receive respectively 98% and 2% of the ingress light (Splitter Type). 302-2 shows that this is the egress of an optical splitter that will receive 98% of the inserted light. 302-3 illustrates that this egress terminal receives only 2% of the input light, which is typically the ‘tap’ of an optical splitter used as tap-coupler.

FIG. 4 depicts a conceptual drawing of an example embodiment of an interconnection means 100 in the form of a long-haul optical fiber between San Jose and Los Angeles. The smart long-haul optical fiber comprises a long-haul optical fiber 400 as interconnection means 100 and two optical fiber connectors. 401 depict a map of California to show the topological route that the exemplified long-haul optical fiber 400 follows. The machine accessible information tag information panels 402-1 and 402-2 display the typical information that will be stored on the respective optical fiber connectors for this example embodiment. In this embodiment the Usage Type representing the embodiment of the interconnection means 100 is ‘Long Haul’. The NearEnd and FarEnd describe respectively the location of the terminal connector to which this machine accessible information tag is attached and the location of the terminal connector on the other side of the long-haul optical fiber. In this example the city and geographical location coordinate are stored. Depending on the particular implementation this information may also contain but is not limited to street address, building number, floor number, and rack number and position. Although the example machine accessible information tag information panels 402-1 and 402-2 only show the total optical loss across the long haul optical fiber 400, most likely the machine accessible information tag will contain more detailed optical characteristic such as but not limited to the results of an Optical Time Domain Reflectometry test ran on 400. The last set of information shown in 402-1 and 402-2 is the physical path 400 follows. The physical path is represented by a list of locations through which 400 passes. For the purposes of clarity only a few of these locations have been listed in 402-1 and 402-2. This location information can have similar properties as that of the terminal connectors as well as additional items such as manhole location and number. Besides the location information, 402-1 and 402-2 also depicts an optical loss for each location since long haul optical fibers such as 400 are typically a concatenation of fiber strains spliced together at these locations in one form or the other (e.g. mechanically, chemically, glued) introducing an additional optical loss. Note that the typical loss is less then the numbers indicated in this picture.

FIG. 5 depicts a conceptual drawing of the typical elements involved in the embodiment of this invention using an add-on type machine accessible information tag 202 and related communication probe 502 mounted on a patch panel mating sleeve 501. The smart patch panel 500 is an embodiment of the network node 110 and comprises one or more mating sleeves 501 equipped with a communication probe 502 to enable it to communicate with inserted optical fiber connectors. 503 represents an optical fiber carrying the optical communication signals when an interconnection is made. The insertion of the optical connector 201 into the mating sleeve 501 will result in the establishment of both an optical path throughout the optical fiber strains 503 and an interconnection of the machine accessible information tag 202 with the communication probe 502. As a result the smart patch panel will be notified of the insertion of the particular interconnection means and will be able to read, change or write the information on the machine accessible information tag. Any type of Interconnection means including optical testers can substitute the patch panel in this embodiment without any major changes to the components. Optionally the mating sleeve 501 can be substituted by an optical transceiver. For the purpose of building a machine accessible information tag programmer/reader device, the same components will be used except there will be no optical fiber 503 connected to the mating sleeve 501. Other variations include mating sleeves that receive machine accessible information tag connectors at both ends. In this variation two optical connectors 201 will be ‘mated’ against each other in the mating sleeve for in order to establish the optical path. Both sides of the mating sleeve will be equipped with machine accessible information tag communication probes 502 so that the relationship of inserted interconnection means can be established in the Network node in which the mating sleeve resides.

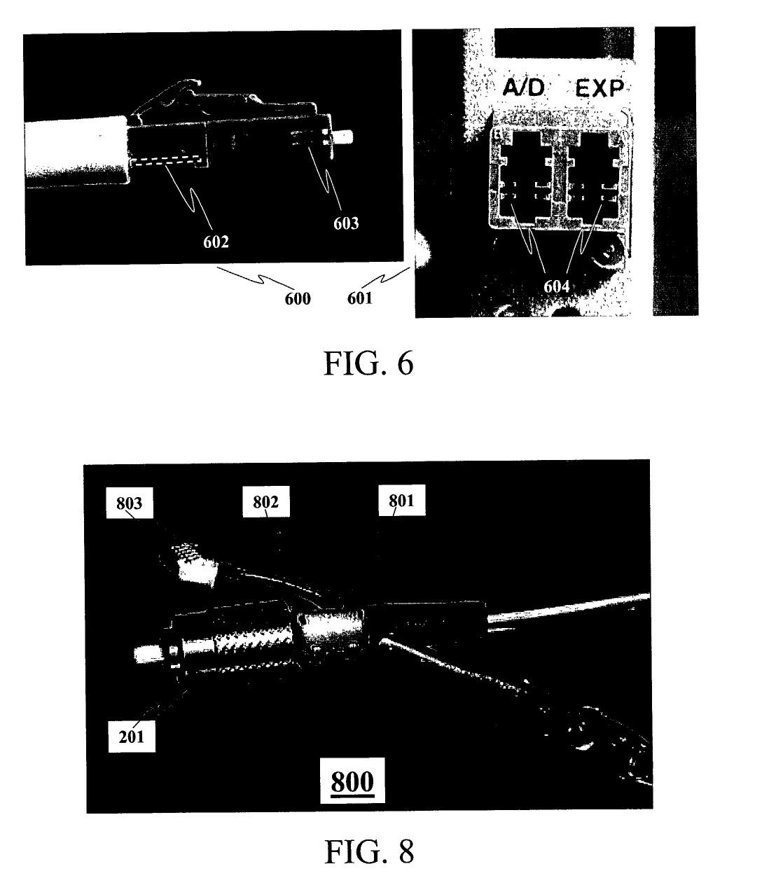

FIG. 6 shows two photographs of an embodiment of this invention using a special purpose LC connector 600 and LC mating sleeve 601. The machine accessible information tag LC connector 600 contains a machine accessible information tag 602 molded in the non-precision part of the connector and connected to the external contacts 603 on both sides of the connector (only one side visible). The special purpose (double) LC mating sleeve 601 contains the necessary contacts 604 which are connected to the in the patch panel integrated communication probe. When the connector 600 is inserted in one of the mating sleeve 600 ports, its contacts 603 will make contact with the contacts 604 of the mating sleeve. This will both trigger the communication probe inside the patch panel and enable it to communicate with the machine accessible information tag 602. Vice-versa when the connector is removed from the mating sleeve the probe will be triggered to indicate the connector's removal.

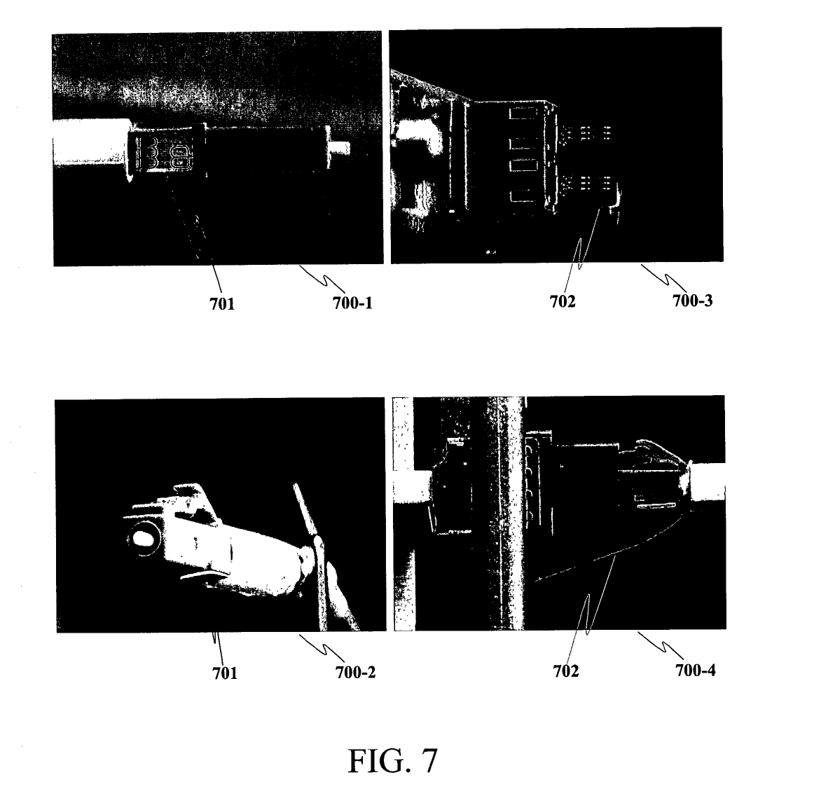

FIG. 7 depicts 4 photographs of a retrofit embodiment of this invention using a regular production LC connector and mating sleeve. Photograph 700-1 shows the bottom view of an LC connector with surface mounted machine accessible information tag add-on 701 while photograph 700-2 shows the same connector with machine accessible information tag add-on 701 from a front-perspective view. Photograph 700-3 shows the top-view of a two port LC mating sleeve mounted in the faceplate of a patch panel and equipped with the machine accessible information tag communication head 702 underneath the mating sleeve. This photograph 700-3 clearly displays the 6 contacts for each of the two machine accessible information tag communication probes in the communication head 702. Note that the number of contacts may vary depending on the particular implementation. Photograph 700-4 shows the side view of an LC connector with surface mounted add-on, plugged into the mating sleeve equipped with a machine accessible information tag communication head 702. This picture demonstrates how the respective contacts of the machine accessible information tag and communication head make contact when the connector is inserted in the mating sleeve. Consequently the communication probe will be triggered on the insertion and removal of the connector and will be able to read, change or write the information on the machine accessible information tag.

FIG. 8 depicts a photograph 800 of the embodiment of this invention in the form of an FC connector 201 with a snap-on type machine accessible information tag on its boot. The snap-on machine accessible information tag comprises of a connector 803, a cord 802 and an attachment mechanism 801. Although the machine accessible information tag 103 itself may be molded into the attachment mechanism 801, it will most likely be build into the connector 803 to eliminate any unnecessary electrical radiation. In the later case, the cord 802 will only be a means for physically constraining the connector to the attachment mechanism 801. While in the former case, the cord 802 will also contain the necessary conduits to electrically connect the machine accessible information tag to the connector's contacts. While the embodiment of the attachment mechanism is a precision molded snap-on device, which ensures that the pressure it produces on the boot is within pre-specified limits, other embodiments such as wire straps are also feasible.

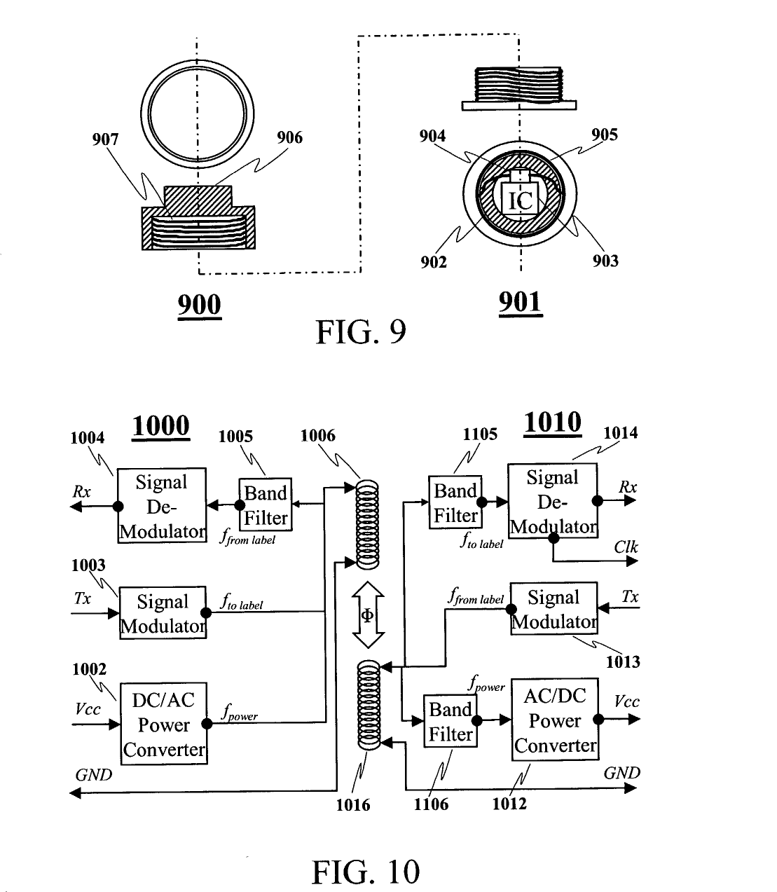

FIG. 9 depicts a schematic and conceptual drawing of a typical contact-less embodiment using an induction coupled tag. Drawing 900 displays the bottom and opened-up side view of the induction couple machine accessible information tag probe's communication head and the opened-up side and top view of the induction coupled machine accessible information tag 901.

The hollow core 902 contains the machine accessible information tag's integrated circuit (IC) 903 and the induction related circuitry 904. Furthermore, it is winded with an electric coil 905, which connects to the induction related circuitry.

The core and base of the machine accessible information tag as well as the enclosure of the tag probe are constructed in a highly magnetic conductive material, which provides a very efficient magnetic coupling between probe and tag when the probe is placed on the tag. Furthermore, it also provides a nearly perfect shield that eliminates most of the external electro-magnetic radiation. This is important because most telecommunication operators have very strict equipment requirements for electromagnetic emissions.

On a side note, the concepts of this invention also cover radio frequency coupled information tags.

The machine accessible information tag probe 900 comprises a highly magnetic conductive hollow anchor 906, which is equipped with an electrical coil 907 on the inside and embedded induction and probe related circuitry (not depicted in this figure).

In a typical embodiment both probe and tag would be protected from environmental conditions such as water, dust and dirt by a rugged laminated enclosure. Probe and tag are constructed such that the probe smoothly slides on top of the tag. A locking mechanism may be implemented but is not required to make the concept functional.

FIG. 10 depicts the electronic block diagram showing the principle operation of the magnetically coupled machine accessible information tag embodiment. 1000 depicts the circuitry related to the magnetic coupling for the probe while 1010 depicts the same for the machine accessible information tag. The probe and machine accessible information tag electronics not related to the magnetic coupling have been omitted for simplicity purposes. The DC/AC power converter 1002 generates an electrical alternating current (AC) signal with a frequency f_{power} from the direct current (DC) source Vcc. The signal modulator 1003 modulates the information to be send from the probe to the label in the form of a digital signal Tx on a carrier frequency f_{to label}. The addition of these two electrical signals will generate a corresponding alternating magnetic flux Φ in the coil 1006 of the probe. As described in FIG. 9, this flux Φ will be conducted through the body of the probe and machine accessible information tag, which form a closed magnetic circuit when the probe is mounted on the machine accessible information tag. Consequently, this flux Φ will also travel through machine accessible information tag coil 1016 which in its turn will generate a corresponding electrical signal similar to the initial electrical signal. This electrical signal is fed to two band filters 1105 and 1106, which will filter out the original signals respectively the digital information modulated on frequency f_{to label} and the power signal with frequency f_{power}. Band filter 1106 feeds this signal to the AC/DC converter 1012, which generates the necessary voltage Vcc and required current to power the machine accessible information tag electronics. Band filter 1105 feeds the modulated information to the Signal Demodulator 1014, which will restore the original signal and feeds it to the receiver Rx of the machine accessible information tag. In this example embodiment it also generates the clock signal Clk for the machine accessible information tag central processing unit (CPU) and peripherals. This signal may also be generated by for instance a crystal oscillator on the machine accessible information tag. However it is usually more cost effective to deduce this signal from signals generated by the probe. Information communicated back from the machine accessible information tag in the form of the digital signal Tx is modulated on a dedicated frequency f_{from label} by a Signal Modulator 1013. The resulting electrical signal is superposed on the signal coming from the coil 1016. As a result it will generate a corresponding current and flux component superposed on the existing signals. Coil 1006 of the probe will pick up this magnetic component of the flux Φ and generate a corresponding superposed electrical signal. Band filter 1005 will in its turn filter out this component related to the communication coming from the machine accessible information tag and feed it to the Signal Demodulator 1004. Signal Demodulator 1004 demodulates this signal and feeds the resulting digital signal to the receiver Rx of the probe. The digital communication signals may be either Amplitude or Frequency Modulated (AM or FM) as long as the resulting signals are spectrally separated from the other signals that make up the total flux Φ in the coils. It should be noted that the different components described in this operation principle may be combined or split depending on economical and physical requirements or limits without affecting the operating principle.

FIG. 11 depicts a conceptual drawing of an example embodiment of an interconnection means 100 in the form of a fiber optical terminator connected to a regular network distribution element. A smart fiber optical terminator for interconnecting network nodes (not depicted) is very similar to a smart patch cord as depicted in FIG. 2 with this difference that it is usually a lot longer and mounted inside a facility between two points. The regular network distribution element 1101 has a port 1103, which receives terminal connector 200 and relays the information back and forth through 1105, but is not able to communicate with a machine accessible information tag. Therefore terminal connector 1105 has not been equipped with a machine accessible information tag for this example. Terminal connector port 1103 may be implemented by a mating sleeve in which case 1104 is another optical fiber or it may be implemented by a transceiver in which case 1104 is most likely a electrical conductor. Besides the Usage Type, Insertion Loss and Length, the machine accessible information tag information panel 1106 also shows that Far End information such as location and connected device are stored on the machine accessible information tag. Since 1101 is not capable of communicating with 1105 and announcing their relationship to the operation support system, the far end information depicted in 1106 and stored on 202 needs to be entered through human intervention. Different scenarios for this are:

1. using a manual programming device for the initial setup of the smart fiber optical terminator;

2. directly instructing the network node in which the smart fiber optical terminator will be (is) plugged in, to program it;

3. instructing the operation support systems to program 202, which will then relay this instruction to the first smart distribution element that announces the detection of 201 and 202.

Most fiber optical terminator implementations will probably equip both terminal connectors with machine accessible information tags and upload them with the static information such as location, length and route because this already is an added value for manually maintaining the physical infrastructure. Although this embodiment is a full-fledged smart fiber optical terminator, the programming procedures for the smart terminal connector inserted into the network node will be similar as above.

It should be noted that even if none or just part of the machine accessible information tags of a interconnection means are connected to network nodes on a regular basis, this invention still adds value to prior art solutions since it puts a lot of valuable information at the hands of a field technician inspecting the interconnection means without requiring a connection to a centralized database.

It will be understood that the particular embodiments described above are only illustrative of the principles of the present invention, and that various modifications could be made by those skilled in the art without departing from the spirit and scope of the present invention. For example, the present invention may be advantageously used with other types of optical network elements, such as OADMs, optical cross-connects, and the like. Accordingly, the scope of the present invention is limited only by the claims that follow.

We claim:

1. A system for improving the management of information related to physical resources in networks, comprising:
a plurality of interconnection means, wherein each said interconnection means is a said physical resource which has at least two termination points and is selected from a group consisting of a single interconnection medium or an interconnect bundle comprising a plurality of said interconnection means;
a plurality of network nodes, wherein each said network node is a said physical resource that can be connected to any said network node through said interconnection means in which each said network node is connected to an individual said termination point of the said interconnection means;
at least one machine accessible information tag disposed along side at least one said interconnection means containing information that at least uniquely identifies the interconnection means;
at least one tag interface capable of communicating with a coupled said machine accessible information tag; and
at least one tag communication device capable of connecting to the said tag interface for reading and optionally writing, updating and erasing part or all the information stored on the said machine accessible information tag based on human or machine interactions.

2. The system according to claim 1, wherein the said machine accessible information tag is a smart information tag capable of performing more complex functions which may include advanced communication protocols, reading sensors and controlling peripherals.

3. The system according to claim 1, wherein at least one said network node incorporates said tag communication device and wherein at least one said machine accessible information tag is machine accessible through at least one said termination point of the said interconnection means such that the said network node detects the coupling and decoupling of the said machine accessible information tag to said tag interface.

4. The system according to claim 3, wherein at least one said network node has at least one port to which said termination points can be coupled and wherein said network node is able to correlate the coupling of a particular said machine accessible information tag to said tag interface with the coupling of a particular termination point of the interconnect medium along which the said machine accessible information tag is disposed to a particular port of the network node.

5. The system according to claim 4, wherein at least one said network node is able to communicate coupling and decoupling information to a management system.

6. The system according to claim 5, wherein for at least one said port the coupling and decoupling of a said termination point is inherently related to the coupling and decoupling of the said machine accessible information tag with the said tag interface of the network node to which the port belongs.

7. The system according to claim 6, wherein said network is a communication network; said termination point is a connector; said port is receptacle of a said connector; said network node is a communication network node; and said interconnect medium is a communication medium.

8. The system according to claim 7, wherein said network is a optical communication network; said connector is an optical connector; said network node is an optical network node, and said interconnect medium is an optical medium.

9. The system according to claim 8, wherein said optical medium selected from a group consisting of optical fiber, passive optical splitter, passive optical combiner, active optical wavelength selective coupler, optical add/drop multiplexer (OADM).

10. The system according to claim 1, wherein said communication and coupling means between the said tag interface and said machine accessible information tag selected from a group consisting of electrical leads and contacts, electromagnetic induction in an electromagnetic conductive enclosure, radio frequency electromagnetic waves, photons in open space or photons in an optical medium.

11. A method for improving the management of information related to physical resources in networks by dispersing this information on machine accessible information tags disposed alongside the related said physical resources; the method comprising:
disposing machine accessible information tags alongside at least one interconnection means in a network by attaching them to the said interconnection means, by pre-integrating them into the said interconnection means or components thereof, or by a combination of the previous;
coupling said machine accessible information tag to the tag interface of a tag communication device; and
storing information on the said machine accessible information tag by means of the said tag communication device;

12. The method for improving the management of information related to physical resources in networks as claimed in 11 and further comprising the steps of:
coupling said machine accessible information tag to said tag interface of a said tag communication device; and
retrieving said information from the said machine accessible information tag by means of the said tag communication device.

13. The method for improving the management of information related to physical resources in networks as claimed in 12 and further comprising the step of:
updating said information on the said machine accessible information tag by means of the said tag communication device.

14. The method for improving the management of information related to physical resources in networks as claimed in 13, further comprising the steps of:
prior to and after the said updating step, synchronizing said information related to the particular said machine accessible tag with one or more centralized or decentralized management system either online or offline and either individually or in badge.

15. The method for improving the management of information related to physical resources in networks as claimed in 14, further comprising the steps of:
prior to and after the said updating step, synchronizing said information related to the particular said machine accessible tag with one or more centralized or decentralized management system either online or offline and either individually or in badge.

16. The method for improving the management of information related to physical resources in networks as claimed in 12, wherein said coupling of a machine accessible information tag to tag interface is directly related to the coupling of the termination point associated with the said machine accessible information tag to a port of the network node in which the tag interface is incorporated and wherein the said coupling and decoupling is automatically detected; the method further comprising the steps of:
awaiting said coupling or decoupling event of said machine accessible information tag and related termination point;
determining the said port to which the said coupling or decoupling event relates.
in case of a coupling, retrieving specific parts or all the information from the said machine accessible information tag depending on preprogrammed steps or specific policies configured in the network node;
informing none, one or more other system of the said coupling and decoupling event and related information depending on the network node configuration.

17. The method for improving the management of information related to physical resources in networks as claimed in 16, wherein at least one said other system instructs at least one said network node to update some or all of the information on at least on of the said coupled machine accessible information tags.

18. The method for improving the management of information related to physical resources in networks as claimed in 16, wherein at least one of the said other systems receives information from a plurality of said network nodes and has the means to correlate it and establish and maintain a topological view of the network in which the said network nodes are involved.

19. The method for improving the management of information related to physical resources in networks as claimed in 16, wherein said network node contains functionality means to maintain a node connectivity view by correlating the information of the said coupled machine accessible information tags, their related termination points and the ports to which they are coupled.

20. The method for improving the management of information related to physical resources in networks as claimed in 12, wherein after said coupling and prior to any other communication such as said retrieving, updating or writing information from or to the said machine accessible information tag an authentication and authorization procedure needs to be successfully completed.
